(19) United States
(12) Patent Application Publication
(10) Pub. No.: US 2007/0209253 A1
(43) Pub. Date: Sep. 13, 2007

(54) Music reference sheet storage and display system and method therefor

(76) Inventor: Glen West, Glendale, AZ (US)

Correspondence Address: WEISS & MOY PC, 4204 NORTH BROWN AVENUE, SCOTTSDALE, AZ, 85251, US

(21) Appl. No.: 11/365,363

(22) Filed: Mar. 1, 2006

(51) Int. Cl. G09F 11/00

(52) U.S. Cl. 40/491

(57) ABSTRACT

A music reference sheet storage and display system has at least one music reference sheet. At least one music sheet box is provided to store the music reference sheet. The music sheet box has a first opening so the music reference sheet may be extend out of the music sheet box and displayed.

### BACKGROUND OF THE INVENTION

1. Field of the Invention

This invention relates to music and, more specifically, to a music reference sheet storage and display system which can store and display a plurality of different music sheets and/or reference material.

2. Description of the Prior Art

When teaching someone how to play a musical instrument, a music teacher will generally place either a book or a loose sheet of paper(s) on a music stand and/or podium. During the music lesson, there inevitably will arise the need for some supplementary or reference material that the student could not remember or that the teacher, could use to further explain or expand the current lesson. In these situations, one of the following generally happens: either the student will go fishing through their folder to find the paper needed to reference or the music teacher will have to go through his/her file drawers to find the particular desired material. Once the desired reference sheet is finally located, the music teacher then needs to try and place the reference sheet on the music stand so that it will sit on the music stand and be visible while at the same time not covering up the main lesson sheet or book that is being taught. Presently this is usually done by slipping/wedging the reference sheet behind the other papers or music book in hopes that the reference sheet will stick up above or to the side of the material presently being worked on and not slip back down behind the music book or off the music stand.

Therefore, a need existed to provide an improved music reference sheet storage and display system. The improved music reference sheet storage and display system would be able to store and display a plurality of different music sheets and/or reference materials simultaneously. The improved music reference sheet storage and display system would provide easy and instant access to reference materials while still allowing for the use of the music stand for holding and displaying a music book/sheet and the like.

### SUMMARY OF THE INVENTION

In accordance with one embodiment of the present invention, it is an object of the present invention to provide an improved music reference sheet storage and display system.

It is another object of the present invention to provide an improved music reference sheet storage and display system that is able to store and display a plurality of different music sheets and/or reference material simultaneously.

It is another object of the present invention to provide an improved music reference sheet storage and display system that provides for easy and instant access to reference materials while still allowing for the use of the music stand.

The foregoing and other objects, features, and advantages of the invention will be apparent from the following, more particular, description of the preferred embodiments of the invention, as illustrated in the accompanying drawing.

### BRIEF DESCRIPTION OF THE EMBODIMENTS

In accordance with one embodiment of the present invention a music reference sheet storage and display system is disclosed. The music reference sheet storage and display system has at least one music reference sheet. At least one music sheet box is provided to store the music reference sheet. The music sheet box has a first opening so the music reference sheet may be extend out of the music sheet box and displayed.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a front view of the music reference sheet storage and display system of the present invention placed on top of a music stand.

FIG. 2 is a front view of music reference sheets used in the music reference sheet storage and display system of the present invention.

FIG. 3 is a perspective view of one storage container used in the music reference sheet storage and display system of the present invention.

FIG. 4 is a perspective view of a second storage container used in the music reference sheet storage and display system of the present invention.

FIG. 5 is a perspective view of the storage container depicted in FIG. 3 showing holding devices to secure the music reference sheets in an extended position.

FIG. 6 is a perspective view showing the first and second storage containers coupled together to form one side of the music reference sheet storage and display system of the present invention.

FIG. 7 is a perspective view showing the first and second storage containers coupled together to form a second side of the music reference sheet storage and display system of the present invention.

### DETAILED DESCRIPTION OF THE PREFERRED EMBODIMENT

Referring to the Figures, a music reference sheet storage and display system 10 (hereinafter storage and display system 10) is shown. The storage and display system 10 will allow a music teacher or student to store and display a plurality of different music sheets and/or reference sheets 12 (hereinafter music sheets 12) simultaneously. The storage and display system 10 would provide easy and instant access to music sheets 12 while still allowing for the full use of the music stand 14 for holding and displaying a music book, additional music sheets, and the like.

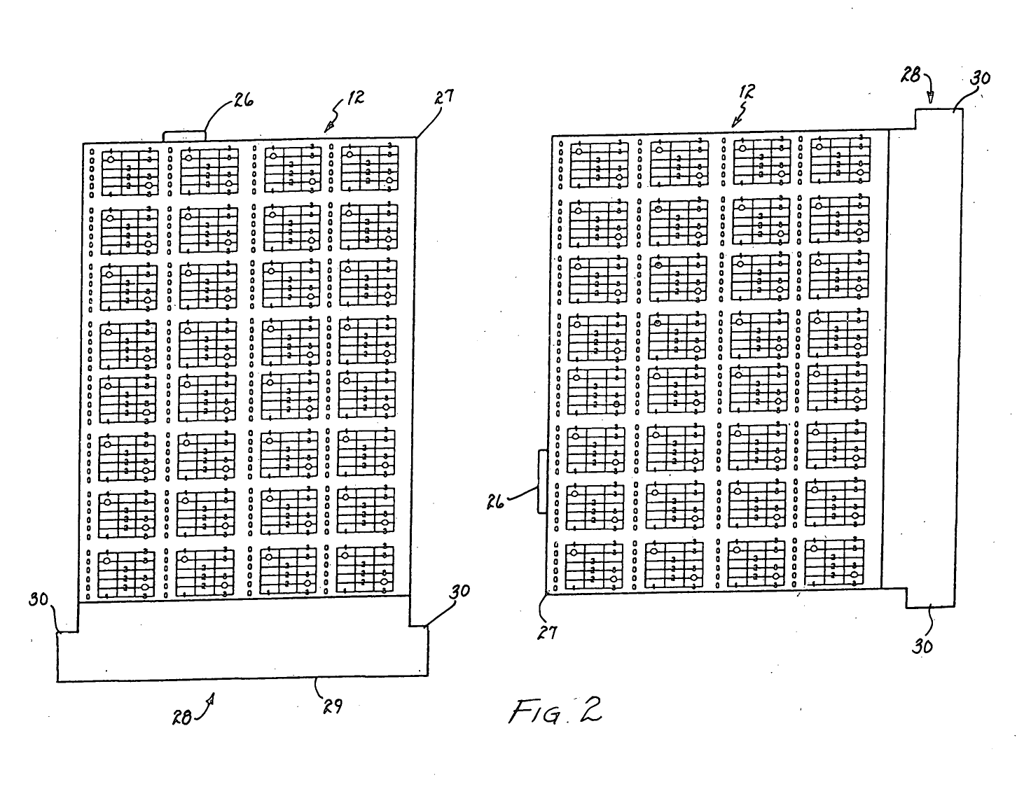

The storage and display system 10 is comprised of a plurality of storage boxes 16. Each storage box 16 is used to store one or more music sheets 12 (see FIG. 2). Each storage box 16 is also able to display a particular stored music sheet 12 when desired.

Each storage box 16 is comprised of a main body section 18. The body section 18 is generally a rectangular box in shape and made out of a light weight but sturdy material. For example, the body section 18 may be made out of plastic, acrylic, wood, aluminum, or the like. The listing of the above should not be seen as to limit the scope of the present invention. The body section 18 will have flat front and rear surfaces so that items may be coupled and/or placed on these surfaces.

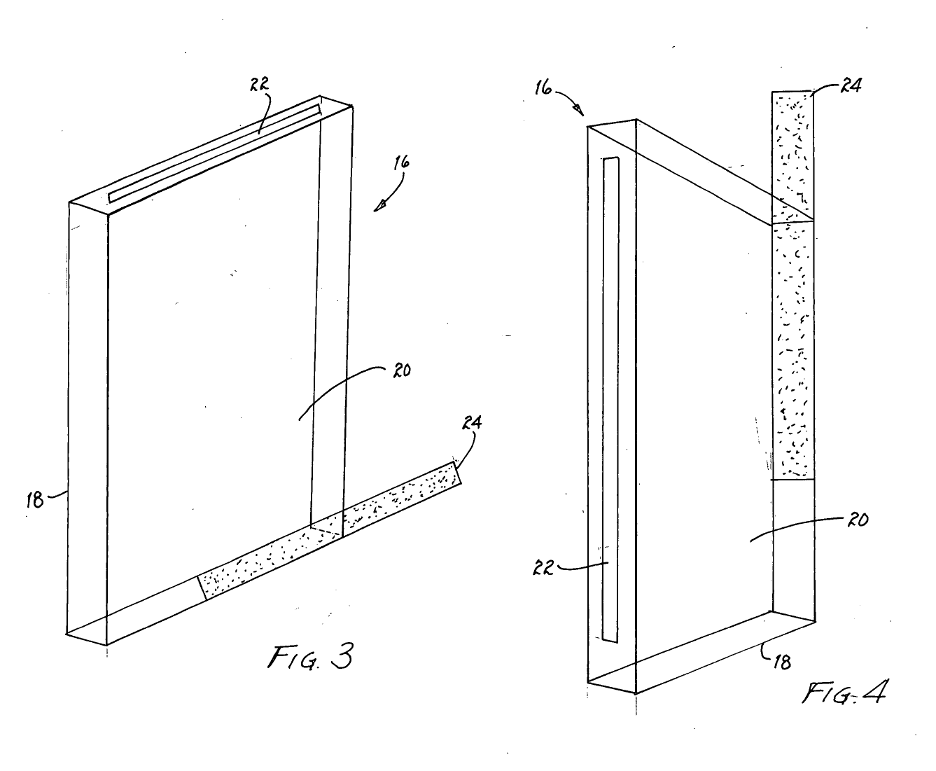

The body section 18 will have a cavity 20 formed therein. The cavity 20 thus creates a hollow interior in the body section 18. The cavity 20 will be of sufficient size to hold and store one or more music sheets 12. A thin opening 22 is formed along one side of the body section 18. The thin opening 22 will allow the music sheets 12 to slide in and out of the body section 18 in order to be displayed but not completely removed from the body section 18. On a side opposite of the thin opening 22 is a cover member 24. The cover member 24 is removable from the body section 18. This will allow one to have access to the cavity 20 in order to change out the music sheets 12. In accordance with one embodiment of the present invention, the cover member 24 is a sliding cover as shown in FIGS. 3 and 4. One can thus slide the cover member 24 on and off to open and close off the cavity 20.

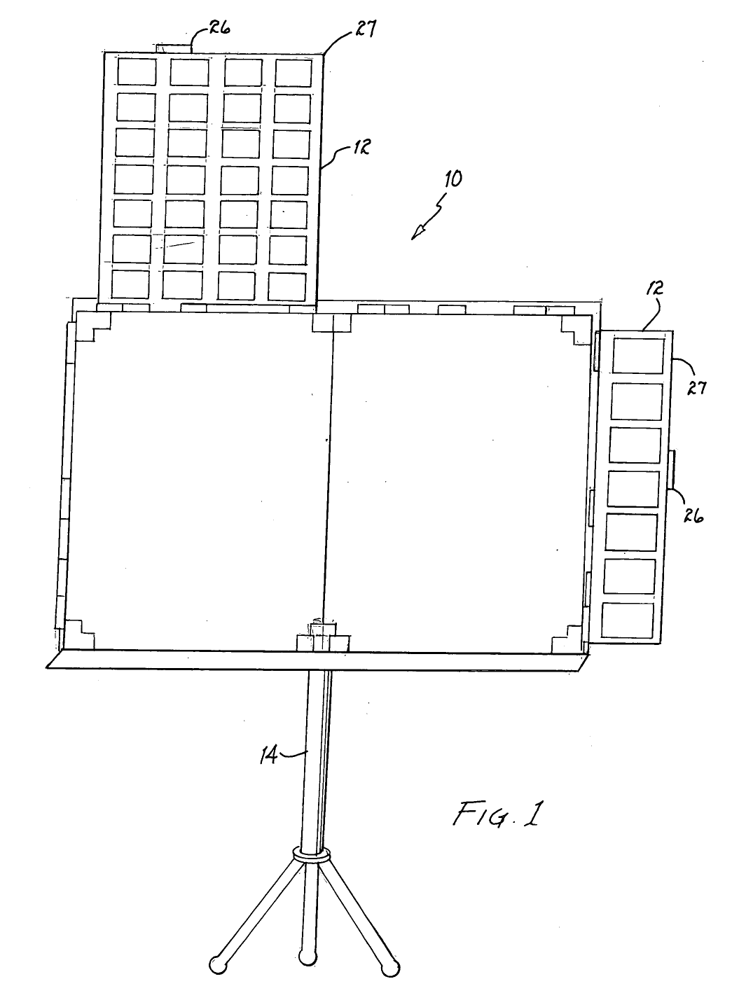

Once the cover member 24 is removed, one or more music sheets 12 may be placed in the cavity 20. As seen in FIG. 2, each music sheet 12 has a identifying tab 26 located on a first edge 27 of the music sheet 12. The identifying tab 26 is used to differentiate between the different sheets. As seen more clearly in FIG. 1, the identifying tab 26 extends out of the thin opening 22 and slightly above the body section 18. The identifying tabs 26 are located at different positions along the first edge 27 for each music sheet 12. Thus, as seen in FIG. 1, each identifying tab 26 for each music sheet 12 may be seen extending out of the thin opening 22 thereby allowing one to differentiate between the different music sheets 12.

Located at an edge 29 opposite of the first edge 27 is a holding member 28. The holding member 28 is used to secure the music sheet 12 in an extend position when a user wants to view that particular music sheet 12. The holding member 28 further prevents the music sheet 12 from being completely removed from the body section 18 through the thin opening 22. In accordance with one embodiment of the present invention, the holding member 28 is comprised of a pair of flaps 30. A flap 30 extends out from each side of the edge 29 opposite of the first edge 27. The flaps 30 extend the edge 29 so that the edge 29 is bigger than the thin opening 22 thereby preventing the music sheet 12 from being pulled completely through the thin opening 22.

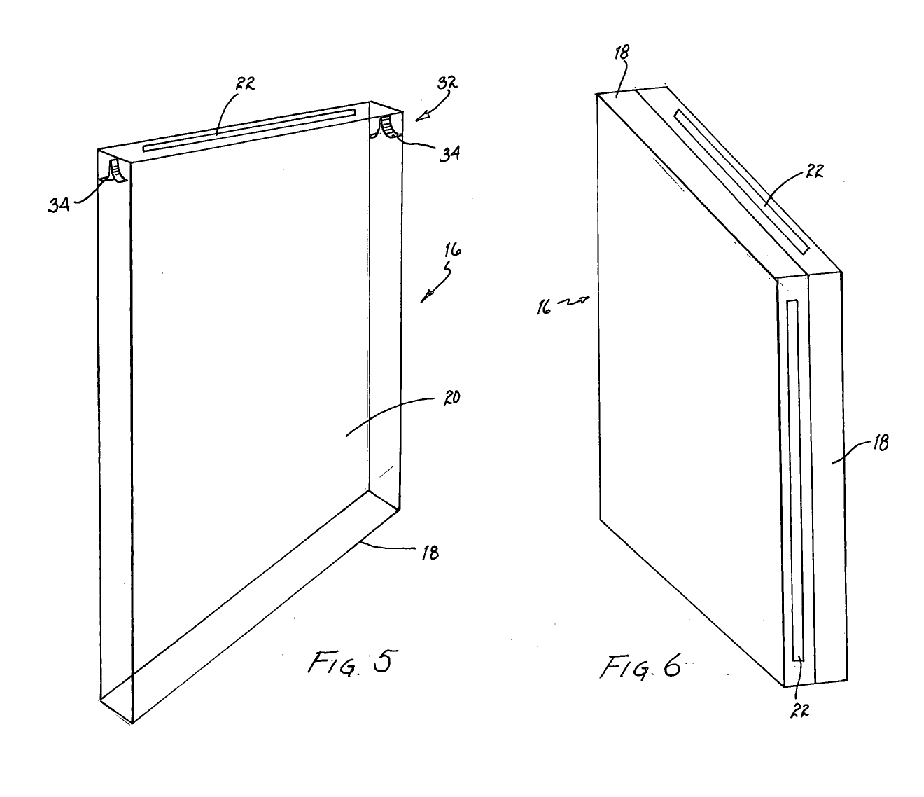

Referring to FIG. 5, when the music sheet 12 is pulled out of the thin opening 22, the music sheet 12 needs to be secured in an extended position in order to be seen. A music sheet holder 32 is used to secure the music sheet 12 in an extended position out of the thin opening 22. In accordance with one embodiment of the present invention, the sheet holder 32 is comprised of a pair of clips 34. An individual clip 34 is located on each side of the thin opening 22 within the cavity 20 of the body section 18. In operation, individual flaps 30 from the music sheet 12 are inserted into the clip 34 to hold the music sheet 12 in an extend position out of the thin opening 22. If the music sheet 12 is no longer needed, a user just needs to remove the music sheet 12 so that the flaps 30 are moved out of the clips 34. Once the flaps 30 are out of the clips 34, the music sheet 12 may be lowered back into the cavity 20 of the body section 18.

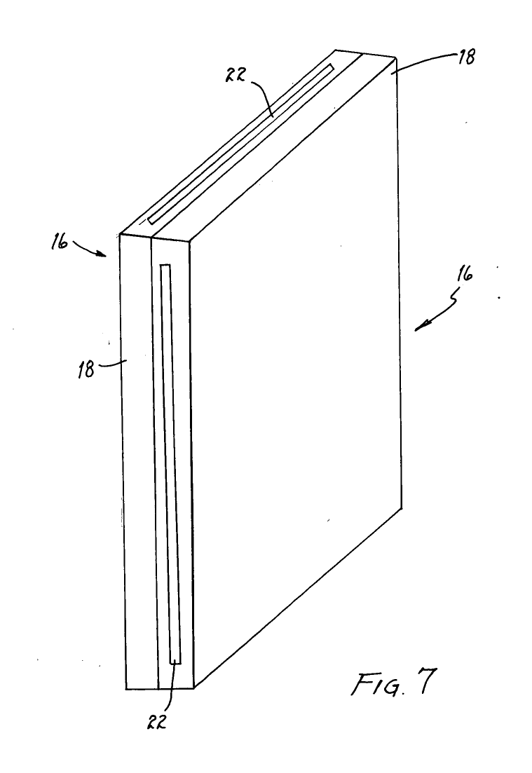

To increase the number of available music sheets 12, two storage box 16 will be positioned on top of one another as shown in FIGS. 6 and 7. The storage boxes 16 are coupled to one another so that one thin opening 22 is located at a top section of a storage box 16 and a second thin opening 22 is located at a side section of another storage box 16.

In operation, the storage and display system 10 will have two sets of two storage boxes 16 that sit side-by-side and flat on the music stand. The storage boxes 16 will be positioned so that two storage boxes 16 will sit side by side on the music stand with the thin openings 22 on the outer edges of the music stand. Two other storage boxes 16 will be coupled either on top or behind and have the thin openings 22 located on top. Since the storage boxes 16 have flat front and rear surfaces, the storage and display system 10 will sit level on a music stand while still allowing for a music book, additional music sheets, and the like to be held and displayed on top of the storage and display system 10.

The storage boxes 16 need to be coupled to each other and to the music stand so that the storage boxes 16 will not slide and move. The storage boxes 16 are generally removably coupled to each other and to the music stand so that different storage boxes may be coupled together and to the music stand. In accordance with one embodiment of the present invention, magnets are used to coupled the storage boxes 16 to each other and to the music stand. Other device to use may include, but is not limited to, hook and loop material, male/female snaps, and the like. The listing of the above should not be seen as to limit the scope of the present invention.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A music reference sheet storage and display system comprising:
at least one music reference sheet; and
at least one music sheet box to store the at least one music reference sheet, the at least one music sheet box having a first opening so the at least one music reference sheet may be extend out of the at least one music sheet box and displayed.

2. A music reference sheet storage and display system in accordance with claim 1 wherein each of the at least one music reference sheet comprises:
a music sheet;
an identifying tab located on a first edge of the music sheet to differentiate between different music sheets, the identifying tab extending out of the first opening; and
a holding member located on an edge opposite of the first edge to secure the music sheet in an extend position when a user wants to view the music sheet.

3. A music reference sheet storage and display system in accordance with claim 2 wherein the holding member further prevents the music sheet from being completely removed from the body section through the first opening.

4. A music reference sheet storage and display system in accordance with claim 2 wherein the holding member comprises a flap member, the flap member extending out from each side of an edge opposite of the first edge to prevent the music sheet from being pulled completely through the first opening.

5. A music reference sheet storage and display system in accordance with claim 1 wherein the at least one music sheet box comprises:
a main body section having a hollow interior to store the at least one music reference sheet, the first opening formed along one side of the body section to allow the at least one music reference sheet to slide in and out of the body section to be displayed; and
a second opening formed in the main body section to add and remove the at least one music reference sheet from the main body section.

6. A music reference sheet storage and display system in accordance with claim 5 wherein the at least one music sheet box further comprising a cover member removably coupled to the second opening.

7. A music reference sheet storage and display system in accordance with claim 5 wherein the main body section is rectangular in shape having an approximately flat front and rear surfaces.

8. A music reference sheet storage and display system in accordance with claim 5 wherein the at least one music sheet box further comprising a holding member placed in the first opening to secure the music reference sheet in an extend position.

9. A music reference sheet storage and display system comprising:
a plurality of music reference sheet; and
a plurality of music sheet boxes to store the plurality of music reference sheets, each of the music sheet boxes having a first opening so that each of the plurality of music reference sheets may be extend out of each of the music sheet boxes and displayed;
wherein each of the plurality of music reference sheets comprises:
a music sheet;
an identifying tab located on a first edge of the music sheet, the identifying tab extending out of the first opening; and
a holding member located on an edge opposite of the first edge to secure the music sheet in an extend position when a user wants to view the music sheet.

10. A music reference sheet storage and display system in accordance with claim 9 wherein the holding member further prevents the music sheet from being completely removed from the body section through the first opening.

11. A music reference sheet storage and display system in accordance with claim 10 wherein the holding member comprises a flap member, the flap member extending out from each side of an edge opposite of the first edge to prevent the music sheet from being pulled completely through the first opening.

12. A music reference sheet storage and display system in accordance with claim 9 wherein each of the plurality of music sheet boxes comprises:
a main body section having a hollow interior to store the at least one music reference sheet, the first opening formed along one side of the body section to allow the at least one music reference sheet to slide in and out of the body section to be displayed; and
a second opening formed in the main body section to add and remove the at least one music reference sheet from the main body section.

13. A music reference sheet storage and display system in accordance with claim 5 wherein each of the plurality of music sheet boxes further comprising a cover member removably coupled to the second opening.

14. A music reference sheet storage and display system in accordance with claim 12 wherein the main body section is rectangular in shape having an approximately flat front and rear surfaces.

15. A music reference sheet storage and display system in accordance with claim 5 wherein each of the plurality of music sheet boxes further comprising a holding member placed in the first opening to secure the music reference sheet in an extend position.

16. A music reference sheet storage and display system comprising:
at least one music reference sheet; and
at least one music sheet box to store the at least one music reference sheet, the at least one music sheet box having a first opening so the at least one music reference sheet may be extend out of the at least one music sheet box and displayed, wherein the at least one music sheet box comprises:
a main body section having a hollow interior to store the at least one music reference sheet, the first opening formed along one side of the body section to allow the at least one music reference sheet to slide in and out of the body section to be displayed; and
a second opening formed in the main body section to add and remove the at least one music reference sheet from the main body section.

17. A music reference sheet storage and display system in accordance with claim 16 wherein the at least one music sheet box further comprising a cover member removably coupled to the second opening.

18. A music reference sheet storage and display system in accordance with claim 16 wherein the at least one music sheet box further comprising a holding member placed in the first opening to secure the music reference sheet in an extend position.

19. A music reference sheet storage and display system in accordance with claim 16 wherein each of the at least one music reference sheet comprises:
a music sheet;
an identifying tab located on a first edge of the music sheet to differentiate between different music sheets, the identifying tab extending out of the first opening; and
a holding member located on an edge opposite of the first edge to secure the music sheet in an extend position when a user wants to view the music sheet and prevents the music sheet from being completely removed from the body section through the first opening.

20. A music reference sheet storage and display system in accordance with claim 19 wherein the holding member comprises a flap member, the flap member extending out from each side of an edge opposite of the first edge to prevent the music sheet from being pulled completely through the first opening.
